(19) United States
(12) Patent Application Publication
(10) Pub. No.: US 2010/0061581 A1
(43) Pub. Date: Mar. 11, 2010

(54) Sound producing device

(75) Inventors: Juarsa Soetejo, Singapore (SG); Huang Pheng Ang, Singapore (SG); Hui Ling Gan, Singapore (SG); Mingliang Chong, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd, Singapore (SG)

(21) Appl. No.: 12/207,474

(22) Filed: Sep. 9, 2008

(51) Int. Cl. H04R 1/10

(52) U.S. Cl. 381/380

(57) ABSTRACT

A sound producing device comprising a sound producing member adapted to fit at an entrance of an ear canal of a user's ear, and a hooking member pivotable about the sound producing member between a first configuration wherein the hooking member is hooked to the user's ear, and a second configuration wherein the hooking member is unhooked from the user's ear. The hooking member comprising a cord holder pivotable at a first end about the sound producing member, and a cord held by the cord holder at a second end of the cord holder. The cord is shaped in a manner such that it curves from the front of the user's ear to the back of the user's ear in the first configuration, wherein the cord holder has a substantially larger cross-sectional area compared with the cross-sectional area of the cord for aiding the user to grip onto the cord holder during use of the sound producing device.

### FIELD OF THE INVENTION

The present invention relates to a sound producing device, in particular, relating to ear hook earphones, neckphones or headphones.

### BACKGROUND

It has been observed that some people are not able to fit conventional earphones snugly in their concha cavity, i.e. an area just outside the ear canal, or within their ear canal (for insert, in-ear or “earplug” type earphones), and the earphones can be easily dislodged from the ears by slight pulling of the earphone wires or by light knocks to the earphones. To address this issue, some earphones are designed to have clip-on or hook-on features to hook over users' ears to prevent the movement of the earphones when they are fitted to the ears. Such clip-on or hook-on features are also implemented on some headphones.

An example of earphones having the clip-on feature is EP-510 from Creative Technology™. Each side of the earphones comprises a hook pivotable about the earphone. A problem with this design is that the hook is rather thick especially at the portion extending from the earphone towards the ear apex, i.e. the foot of the outermost rim of the ear located above the concha cavity where a head-ear groove resides. When wearing the earphone, the thickness of the hook causes some discomfort to the user. Furthermore, the inverted U shape does not fit comfortably over the user's ears.

An example of clip-on earphones having a more complicated design is A8 Earphones from Bang & Olufsen™. Each side of the earphones comprises a rigid hook that is pivotably and rotatably coupled to a rod-like extension at a hook-extension joint. Movements of the rigid hook about the hook-extension joint are dampened so that the rigid hook can stay in its adjusted position. A problem with such a design is the complicated design of the hook-extension joint and it takes some time to adjust the earphone to a comfortable fit over the ear. Also, the rigid hook causes much discomfort when it is pressed against the ears.

Yet another example is ATH-EC700 ear-bud/clip-on hybrid headphones from Audio-Technica™. Each side of the ear-bud/clip-on hybrid headphone comprises a support arm pivotably coupled to the headphone and a hook. The support arm and the hook are both adjustable to pivot along the same plane at their respective pivoted connections. Some problems with such a design are difficulty in clipping on the headphone to the ears and discomfort on the ears due to poor contact with the ear.

A need therefore arises to provide a sound producing device to address at least one of the afore-mentioned problems.

### SUMMARY

According to an aspect of the present invention, there is provided a sound producing device comprising: a sound producing member adapted to fit at an entrance of an ear canal of a user's ear; and a hooking member pivotable about the sound producing member between a first configuration wherein the hooking member is hooked to the user's ear, and a second configuration wherein the hooking member is unhooked from the user's ear, the hooking member comprising: a cord holder pivotable at a first end about the sound producing member; and a cord held by the cord holder at a second end of the cord holder, the cord is shaped in a manner such that it curves from the front of the user's ear to the back of the user's ear in the first configuration, wherein the cord holder has a substantially larger cross-sectional area compared with the cross-sectional area of the cord for aiding the user to grip onto the cord holder during use of the sound producing device.

The cord may be flexible and has shape memory characteristics.

The cord may be substantially arcuate in shape and is skewed at an end portion in a direction toward the user's head in the first configuration.

The curvature of the cord beyond the user's ear apex may be substantially following a contour of an ear groove running adjacent to an outmost rim of the user's ear at the back of the ear, wherein the ear groove begins from close to the user's ear apex and ends close to the back of the user's ear lobe.

The free end of the cord may be encapsulated by a cover having rounded edges.

The cover may have a frictional surface.

The cord holder may have a cross-sectional area about 16 times larger than the cross-sectional area of the cord.

The surface area of the cord holder may be printed with an indicia.

The cord may be made of metal.

The cord holder may be deformation resistant.

The sound producing device may further comprise a support arm connected to the sound producing member and the hooking member is pivotably coupled to the support arm, wherein the hooking member is pivotable about said coupling with the support arm between the first configuration and the second configuration.

The support arm may be in fixed connection with the sound producing member.

The cord holder may have a substantially larger cross-sectional area compared with the cross-sectional area of the support arm.

The cable holder may comprise a core member and a sheath covering the core member.

The core member may comprise a stopper for preventing the sheath from sliding against the surface of the core member by abutting against a portion of the sheath to prevent the sheath from moving.

### BRIEF DESCRIPTION OF THE DRAWINGS

Embodiments of the invention will be better understood and readily apparent to one of ordinary skill in the art from the following written description, by way of example only and in conjunction with the drawings, in which:

FIG. 1 is a perspective view of an example embodiment of the present invention.

FIG. 2 is a top view of the example embodiment.

FIG. 3 is a side view of the example embodiment.

FIG. 4 is a side view of the example embodiment in use.

FIG. 5 is a side view of another example embodiment of the present invention.

### DETAILED DESCRIPTION

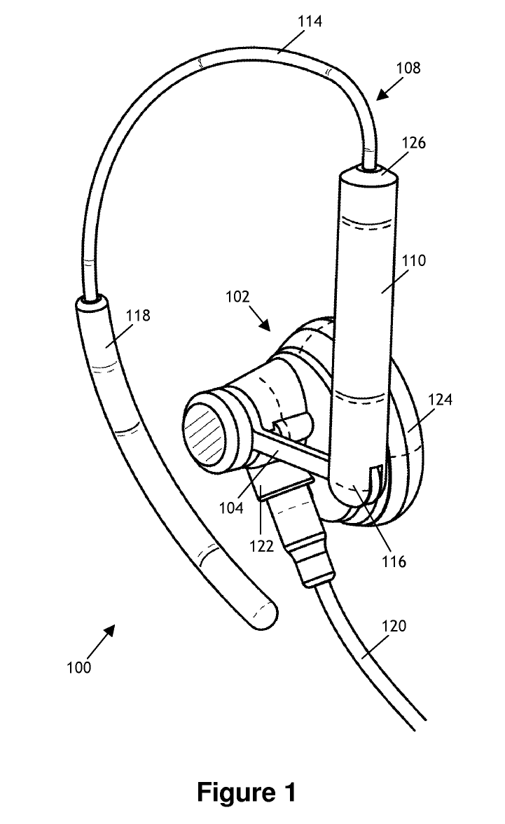

An example embodiment of the present invention is illustrated in FIG. 1. FIG. 1 shows a sound producing device, more specifically, a right side earphone 100 having improved clip-on or hook-on features.

The earphone 100 includes a sound producing member 102 adapted to fit at an entrance of an ear canal of a user's ear (i.e. the concha cavity). The sound producing member 102 contains a right earphone sound driver 124, which is an electromechanical device, such as an acoustic transducer that is suitable for converting electrical analogue sound signals into sound. The sound produced by the driver 124 may cover the full audible frequency range or at least a major portion of the audio frequency range. The sound producing member 102 is connected to a wire 120 through a wire connection port 122. The wire 120 transmits audio signals and power from, for instance, a media player, mobile device, and the like, for reproduction at the sound producing member 102. It is appreciated that in other example embodiments, the earphone may be wireless, e.g. a Bluetooth earphone, and carries its own power source.

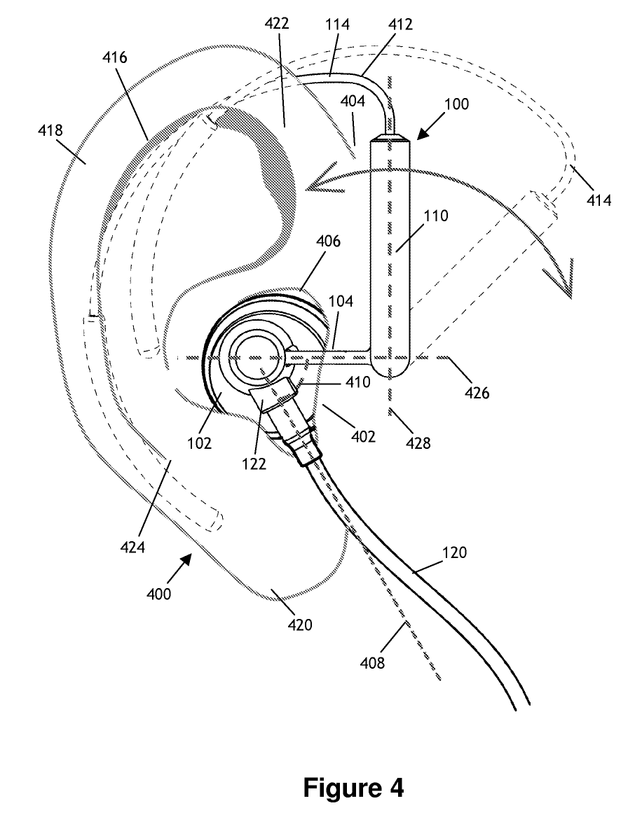

In the example embodiment, there is an elongated support arm 104 in fixed connection with the sound producing member 102, which is not movable relative to the sound producing member 102. The support arm 104 is pre-adjusted to be fixed at a predetermined position relative to the sound producing member 102 that would not cause the support arm 104 to be obstructed by the tragus (402 in FIG. 4). The tragus (402 in FIG. 4) is a protruding part of the ear adjacent to the ear canal of the user's ear. Advantageously, the user has one less adjustment to make at the connection between the support arm 104 and sound producing member 102, as the support arm 104 is already pre-adjusted to the best position. It is appreciated that in another embodiment, the elongated support arm 104 may be pivotably connected to the sound producing member 102 to cater for users who prefer to make their own adjustments at the juncture, i.e. the connection between the support arm 104 and sound producing member 102. It is further appreciated that in another example embodiment, the support arm 104 may be excluded entirely, removing any need for adjustment at the juncture. The hooking member 108 would in this case be coupled directly to the sound producing member 102.

A hooking member 108 for hooking the earphone on the user's ear is pivotably coupled to the support arm 104. The hooking member 108 is pivotable about the coupling with the support arm 104 between a first configuration, i.e. a hooking configuration, wherein the hooking member 108 is hooked to the user's ear to prevent movement of the sound producing member fitted in the ear canal, and a second configuration, i.e. an unhooked configuration, wherein the hooking member 108 is unhooked from the user's ear to aid removal of the sound producing member from the user's ear.

In the example embodiment, the hooking member 108 comprises two portions, a deformation resistant cord holder 110 and a shape memory flexible cord 114 held by the cord holder 110. A first end 116 of the cord holder 110 is pivotably coupled to the support arm 104 to enable the hooking member 108 to pivot about the support arm 104 between the first configuration and second configuration. The cord holder 110 holds the cord 114 in position by holding on to a length of the cord 114 within the cord holder 110 at a second end 126, which is located opposite to the first end 116. In the example embodiment, the cord holder 110 is made of a solidified resinous material, e.g. plastic, and one end of the cord 114 is encased in the cord holder 110. It is appreciated that the cord holder 110 may also be made of metal.

The cord holder 110 is deformation resistant so as to provide better pivoting about the support arm 104. If the cord holder 110 is too flexible, it would deform rather than pivot about the support arm 104 when the user pushes the cord holder 110. This undesirably increases the time a user takes to hook on the earphone 100 to his/her ear.

Furthermore, the cord holder 110 is substantially cylindrical in shape and has a substantially larger cross-sectional area compared with the cross-sectional area of the cord 114 individually. For example, the ratio between the cross-sectional area of the cord holder 110 and the cord 114 can be about 16:1. Compared with the cross-sectional area of the support arm 104, the cord holder 110 also has a substantially larger cross-sectional area. For example, the ratio between the cross-sectional area of the cord holder 110 and the support arm 104 can be about 8:1. Advantageously, the cord holder 110 can provide an adequate gripping portion for the user when he/she is adjusting the hooking member 108 to the best hooking position over the ear. Additionally, the surface area of the cord holder 110 can be printed with an indicia for brand/Trademark labeling, aesthetic decoration, patent number indication, ‘Right’ or ‘Left’ earphone indication, and the like.

The cord 114, as the name suggests, would be regarded herein as having a streamline shape. The streamline shape provides a more comfortable feel on the user's ear compared to having thick plastic ear-hook designs, which are found in some prior art. Also, the cord 114 is substantially arcuate in shape. In the example embodiment, when the hooking member 108 is in hooking configuration, the cord 114 extends from the front of the user's ear to the back of the user's ear, and the cord 114 curves over the user's ear apex (404 in FIG. 4) located in between the front and back of the user's ear to hook onto the ear. The curvature of the cord 114 beyond the user's ear apex (404 in FIG. 4) substantially follows a contour of an ear groove (416 in FIG. 4) at the back of the ear running adjacent to an outmost rim (418 in FIG. 4) of the user's ear. The ear groove begins (416 in FIG. 4) from close to the user's ear apex (404 in FIG. 4) and ends at the back of the user's ear lobe (420 in FIG. 4). It is appreciated that reference made herein to an ear would be with respect to a typical human ear.

Furthermore, in the example embodiment, the cord 114 is flexible and has shape memory characteristics. As such, the cord 114 can be bent on applying sufficient pressure and still return to its original shape without deformation. These characteristics advantageously provide better grip and resilient fit on the ear as the cord 114 can be compressed during adjustment and pushed against the ear in the hooking configuration.

In addition, the free end of the cord 114, i.e. the end not held by cord holder 110, is encapsulated by a cover 118 having rounded edges and a frictional surface. The rounded edges are present to prevent any scratching or discomfort on the skin of the user. The frictional surface provides some grip for resilient fitting of the hooking member 108 over the user's ear. In the example embodiment, the cover 118 is made of an elastic material, e.g. rubber, which is additionally soft and has a better feel on the skin. It is appreciated that other types of material, for instance, plastic can also be considered.

In the example embodiment, the cord 114 is made of metal. More specifically, the cord 114 is made of Nickel-Titanium alloy. It is appreciated that other types of flexible material with shape memory characteristics can also be considered, for instance, certain plastic materials such as Polycarbonate.

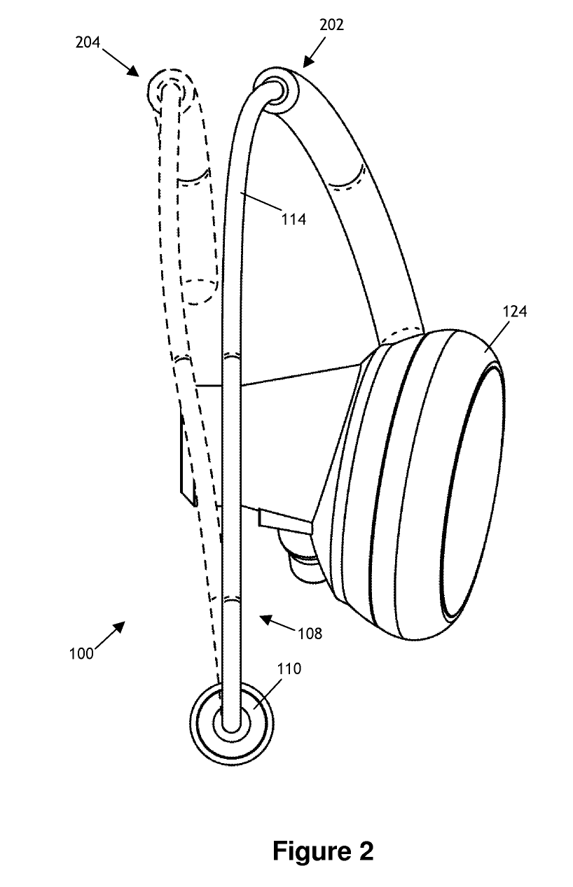

FIG. 2 shows the top view of the earphone 100 described with reference to FIG. 1. FIG. 2 illustrates a first top posture 202 of the cord 114 and a second top posture 204 (as shown by dotted lines), which a user may bend the cord 114 into, during hooking on and removal of the hooking member 108. The first top posture 202 of the cord 114 leans toward the side of the right earphone sound driver 124, i.e. towards the user's head, so that when the cord 114 is hooked on, the tendency to return to its original shape would apply pressure on the ear groove (416 in FIG. 4) located adjacent to the back of the outermost rim (418 in FIG. 4) of the user's ear to provide a resilient fit. The second top posture 204 of the cord 114 lies in the opposite direction of the first top posture 202.

In FIG. 2, the curvature of the original shape of the cord 114 according to the example embodiment is also illustrated. The curvature of the cord 114 in the top view is shown to be curving outwards and downwards away from the cord holder 110. As the cord 114 curves downwards, it reaches a turning point where it would begin to curve backwards, and skew sideway in the direction towards the right earphone sound driver 124, i.e. during the hooking configuration, the skewing direction would be in the direction of the user's head. This shape ensures that the cord 114 generally follows the contour of the ear groove (416 in FIG. 4) at the back of the user's ear as previously described.

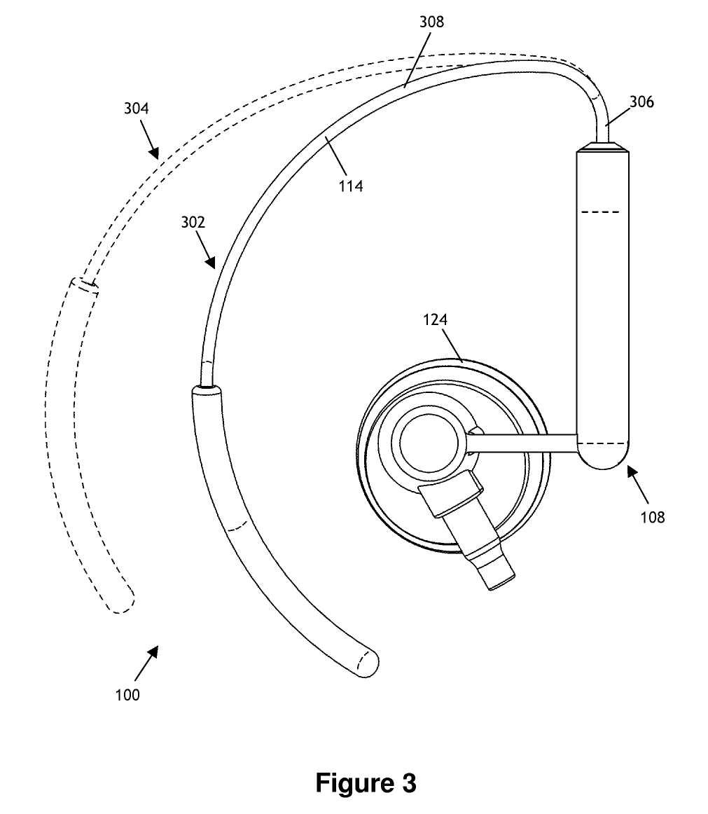

FIG. 3 shows the side view of the earphone 100 described with reference to FIGS. 1 and 2. FIG. 3 illustrates a first side posture 302 of the cord 114 and a second side posture 304 (as shown by dotted lines), which a user may bend the cord 114 into, during hooking on and removal of the hooking member 108. The first side posture 302 of the cord 114 leans toward the side of the right earphone sound driver 124, i.e. toward the back of the user's ear, so that when the cord 114 is hooked on, the tendency to return to its original shape would apply pressure on the ear groove (416 in FIG. 4) located adjacent to the back of the outermost rim (418 in FIG. 4) of the user's ear to provide a resilient fit. The second side posture 304 of the cord 114 lies in the opposite direction of the first side posture 302.

In FIG. 3, the curvature of the original shape of the cord 114 according to the example embodiment is also illustrated. The curvature of the cord 114 in the side view is substantially arcuate. The curvature of the cord 114 is a straight line 306 when it extends out of the cord holder 110. The straight line 306 then curves at about 90 degrees into an arc 308. The straight line 306 extends for a substantially shorter distance compared with the entire length of the cord 114 located external to the cord holder 110. This shape ensures that the cord 114 would follow the contour of the ear groove (416 in FIG. 4) at the back of the user's ear as previously described.

FIG. 4 illustrates the earphone 100 described with reference to FIGS. 1 to 3 when it is hooked on a user's ear 400.

The sound producing member 102 is fitted at the entrance of the ear canal 406 of the user's ear 400 (i.e. the concha cavity).

The support arm 104 is disposed at a position not obstructed by the tragus 402 of the ear 400. Also, the support arm 104 is at a fixed angle 410 e.g. about 60 degrees from a common longitudinal axis 408 of both the wire connection port 122 and the wire 120.

The cord holder 110 is pivotable about the support arm 104 between a hooking configuration 412 towards the front of the ear 400 and an unhooking configuration 414 (as shown in dotted lines) in the opposite direction. In the hooking configuration 412, the cord 114 is hooked to the back of the ear 400. The cord holder 110 sufficiently raises the cord 114 above the ear apex 404 so that the cord 114 can stretch behind the ear 400, and sit roughly alongside an ear groove 416 running adjacent to an outmost rim 418 (also known as helix of a ear) of the user's ear 400 at the back of the ear 400. The ear groove 416 begins at the back of the ear 400 from close to the user's ear apex 404, e.g. a first location 422, and ends at, e.g. a second location 424, at the back of the user's ear lobe 420. In the unhooking configuration 414, the cord 114 is pivoted entirely out of the back of the ear 400.

With reference to FIG. 4, the example embodiment is in the hooking configuration when the longitudinal axis of the support arm 426 is on or about 90 degrees or less with the longitudinal axis of the cord holder 428. The example embodiment is in the unhooked configuration when the longitudinal axis of the support arm 426 is on or about 180 degrees or more with the longitudinal axis of the cord holder 428.

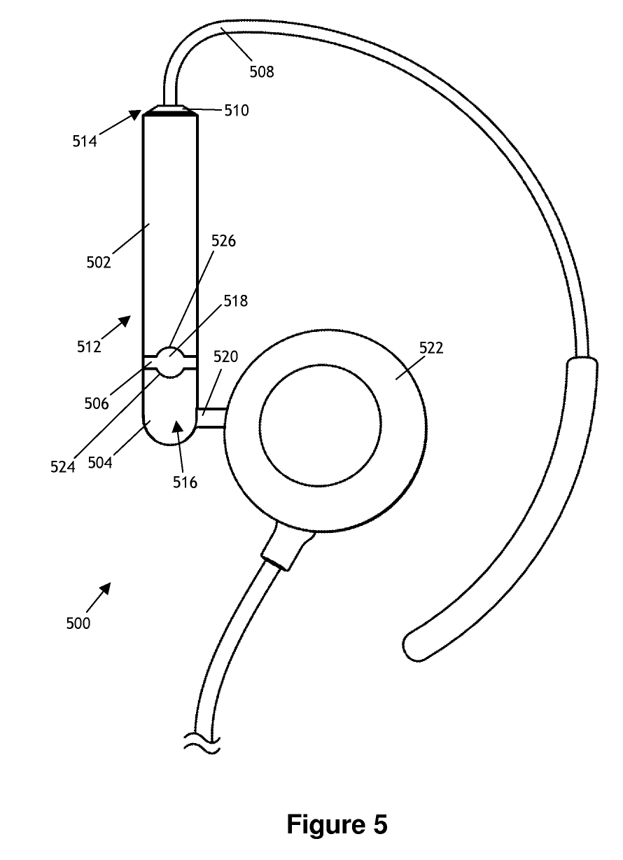

FIG. 5 illustrates a right side earphone 500, which is substantially the same as the earphone 100 described earlier with reference to FIGS. 1 to 4. The difference between the two embodiments is the different design for the cord holder 512. In FIG. 5, the cord holder 512 is substantially cylindrical in shape with two rounded ends 514, 516. The lower end 516 is pivoted to a support arm 520 extending from a sound producing member 522. The upper end 514 is attached to a cord 508. The cord holder 512 includes an upper sheath 502 and a lower sheath 504 covering a rod-like core member 510. Both the upper and lower sheath 502, 504 are glued onto the core member 510. The core member 510 is slightly exposed at a joining interface between the cord holder 512 and the core member 510 while the rest of its body is almost completely covered under the sheaths 502, 504.

In the present example embodiment, the core member 510 is made of a solidified resinous material, e.g. plastic, and it encases a length of the cord 508 to hold the cord 508 in position. Also, the upper sheath 502 and lower sheath 504 have a polished metallic surface. The upper sheath 502 and lower sheath 504 protects the core member 510 from breaking, deformation and scratches, as it is more susceptible to such conditions compared to the metallic sheaths 502, 504. The upper sheath 502 further provides a tightened hold on the length of the cord 508 encased within the core member 510. The upper sheath 502 also provides surface area for including one or more indicia.

In the present embodiment, there is provided a stopper, i.e. in this case a ring-like stopper band 506 protruding from the core member 510 at a location closer to the side of the lower sheath 504. The stopper band 506 includes a circular portion 518 located along its circumference. The stopper band 506 separates the upper sheath 502 and the lower sheath 504 and is used to prevent the lower and upper sheaths 502, 504 from sliding against the surface of the core member 510. More specifically, in this embodiment, the stopper band 506 prevents the lower and upper sheaths 502, 504 from rotating about the longitudinal axis of the cord holder 512 over the surface of the core member 510. Rotation prevention is achieved by abutting the boundaries of the circular portion 518 against corresponding arcuate notches 524, 526 located at respective end portions of the upper and lower sheaths 502, 504. Although two sheaths, i.e. the upper and lower sheaths 502, 504 are described here, it is appreciated that in another embodiment, there can be only one sheath covering the core member 510.

It is appreciated that the features of the example embodiments described with reference to FIGS. 1 to 5 could be similarly applied to a Left side earphone.

It is appreciated that the phrase “fit at an entrance of the ear canal” used herein would cover cupping, covering, blocking or being substantially in close proximity to the ear canal (i.e. covering intra concha, supra aural and supra concha type earphones, headphones, and neckphones) and within the ear canal (i.e. covering insert, in-ear or “earplug” type earphones). It is appreciated that a headphone as described herein would be deemed to be a sound producing device that has a head band and ear covering or cupping sound producing members. A neckphone would be a sound producing device without a head band but has ear hooks on ear covering or cupping sound producing members.

In the case of a headphone or neckphone, the support arm 104 described with reference to FIGS. 1 to 4 is an optional item. In this case, the hooking member (108 in FIG. 1) could be connected directly to the sound producing member (102 in FIG. 1).

Many modifications and other embodiments can be made to the system and its method by those skilled in the art having the understanding of the above described disclosure together with the drawings. Therefore, it is to be understood that the device and its utility is not to be limited to the above description contained herein only, and that possible modifications are to be included in the claims of the disclosure.

1. A sound producing device comprising:
a sound producing member adapted to fit at an entrance of an ear canal of a user's ear; and
a hooking member pivotable about the sound producing member between a first configuration wherein the hooking member is hooked to the user's ear, and a second configuration wherein the hooking member is unhooked from the user's ear, the hooking member comprising:
a cord holder pivotable at a first end about the sound producing member; and
a cord held by the cord holder at a second end of the cord holder, the cord is shaped in a manner such that it curves from the front of the user's ear to the back of the user's ear in the first configuration,
wherein the cord holder has a substantially larger cross-sectional area compared with the cross-sectional area of the cord for aiding the user to grip onto the cord holder during use of the sound producing device.

2. The sound producing device as claimed in claim 1, wherein the cord is flexible and has shape memory characteristics.

3. The sound producing device as claimed in claim 1, wherein the cord is substantially arcuate in shape and is skewed at an end portion in a direction toward the user's head in the first configuration.

4. The sound producing device as claimed in claim 3, wherein the curvature of the cord beyond the user's ear apex is substantially following a contour of an ear groove running adjacent to an outmost rim of the user's ear at the back of the ear, wherein the ear groove begins from close to the user's ear apex and ends close to the back of the user's ear lobe.

5. The sound producing device as claimed in claim 1, wherein a free end of the cord is encapsulated by a cover having rounded edges.

6. The sound producing device as claimed in claim 5, wherein the cover has a frictional surface.

7. The sound producing device as claimed in claim 1, wherein the cord holder has a cross-sectional area about 16 times larger than the cross-sectional area of the cord.

8. The sound producing device as claimed in claim 1, wherein the surface area of the cord holder is printed with an indicia.

9. The sound producing device as claimed in claim 1, wherein the cord is made of metal.

10. The sound producing device as claimed in claim 1, wherein the cord holder is deformation resistant.

11. The sound producing device as claimed in claim 1, the sound producing device further comprising:
a support arm connected to the sound producing member and the hooking member is pivotably coupled to the support arm, wherein the hooking member is pivotable about said coupling with the support arm between the first configuration and the second configuration.

12. The sound producing device as claimed in claim 11, wherein the support arm is in fixed connection with the sound producing member.

13. The sound producing device as claimed in claim 11, wherein the cord holder has a substantially larger cross-sectional area compared with the cross-sectional area of the support arm.

14. The sound producing device as claimed in claim 1, wherein the cable holder comprises a core member and a sheath covering the core member.

15. The sound producing device as claimed in claim 14, wherein the core member comprises a stopper for preventing the sheath from sliding against the surface of the core member by abutting against a portion of the sheath to prevent the sheath from moving.
